(19) United States
(12) Patent Application Publication
(10) Pub. No.: US 2017/0262531 A1
(43) Pub. Date: Sep. 14, 2017

(54) Data Visualization Method and Apparatus, and Database Server

(71) Applicant: Huawei Technologies Co., Ltd., Shenzhen (CN)

(72) Inventors: Anirban Bhattacharya, Bangalore (IN); Janakiraman Thiyagarajah, Bangalore (IN); Bo Hu, Shenzhen (CN)

(21) Appl. No.: 15/608,072

(22) Filed: May 30, 2017

Related U.S. Application Data
(63) Continuation of application No. PCT/CN2015/078443, filed on May 7, 2015.

(30) Foreign Application Priority Data
Nov. 28, 2014 (CN) 201410711878.6

(51) Int. Cl. G06F 17/30

(52) U.S. Cl. CPC G06F 17/30696; G06F 17/30864; G06F 17/30047

(57) ABSTRACT

Embodiments of the present disclosure provide a data visualization method and apparatus, and a database server. The method includes receiving, by a database server, a data query request sent by a request side, where the data query request includes a query condition and a data graph type, acquiring data according to the query condition, where the data graph type is used for presentation of the data, and generating a data graph according to the data and the data graph type. In the embodiments of the present disclosure, a query condition and a data graph type are carried in a data query request, and a data graph is generated inside a database server. Therefore, it is unnecessary to develop software multiple times in different architectures to generate a data graph, which improves resource utilization, and has a relatively low skill requirement for an operator.

### CROSS-REFERENCE TO RELATED APPLICATIONS

This application is a continuation of International Application No. PCT/CN2015/078443, filed on May 7, 2015, which claims priority to Chinese Patent Application No. 201410711878.6, filed on Nov. 28, 2014, both of which are hereby incorporated by reference as if reproduced in their entireties.

### TECHNICAL FIELD

Embodiments of the present disclosure relate to database technologies, and in particular, to a data visualization method and apparatus, and a database server.

### BACKGROUND

In fields of service, such as a big data analytics service, a report generation service, and a state monitoring service, data needs to be graphically presented. A graph is a form that implements data visualization for most systems, and is usually expressed as a bar chart, a pie chart, a stacked chart, and the like.

Currently in the industry, data visualization is mainly implemented in the following manners acquiring original data using a database processing language, processing the original data using a service programming language, and generating a data graph using a service language.

For example, for an application in a browser/server (B/S) architecture, a common implementation manner is acquiring original data using structured query language (SQL), preprocessing the original data using JAVA code, and generating a data graph using a scripting language, that is, JAVASCRIPT code. For a same set of data, or different sets of data having similar structures, in a client/server (C/S) architecture, the implementation manner may become acquiring original data using SQL, preprocessing the original data using C++ code, and generating a data graph using JAVA code.

Therefore, for different architectures, different software needs to be developed to generate a data graph, and therefore, causes a waste of resources in terms of software production.

### SUMMARY

Embodiments of the present disclosure provide a data visualization method and apparatus, and a database server, to avoid a waste of resources caused by data visualization in the prior art.

According to a first aspect, an embodiment of the present disclosure provides a data visualization method, including receiving, by a database server, a data query request for data sent by a request side, where the data query request includes a query condition and a data graph type, acquiring, by the database server, data according to the query condition, where the data graph type is used for presentation of the data, and generating, by the database server, a data graph according to the data and the data graph type.

With reference to the first aspect, in a first possible implementation manner of the first aspect, the generating, by the database server, a data graph according to the data and the data graph type includes determining whether a template corresponding to the data graph type has been loaded into the database server, and if it is determined that the template corresponding to the data graph type has been loaded into the database server, applying the data to the template, to generate the data graph, if it is determined that the template corresponding to the data graph type has not been loaded into the database server, loading the template into the database server and applying the data to the template, to generate the data graph.

With reference to the first possible implementation manner of the first aspect, in a second possible implementation manner of the first aspect, the determining whether a template corresponding to the data graph type has been loaded into the database server includes searching one or more data graph templates stored by the database server, to determine whether the template corresponding to the data graph type exists, and if the template corresponding to the data graph type exists, determining that the template corresponding to the data graph type has been loaded into the database server, or if the template corresponding to the data graph type does not exist, determining that the template corresponding to the data graph type has not been loaded into the database server.

With reference to any one of the first aspect and the first to second possible implementation manners of the first aspect, in a third possible implementation manner of the first aspect, if the data graph type is a customized template, the data query request further includes information indicating a location from which the customized template can be acquired.

With reference to any one of the first aspect and the first to third possible implementation manners of the first aspect, in a fourth possible implementation manner of the first aspect, the generating, by the database server, a data graph according to the data and the data graph type includes generating the data graph according to the data and the data graph type, and generating a uniform resource locator (URL) that points to the data graph, and by the database server, the URL, the method further includes sending, by the database server, the URL as a response to the request side such that the request side accesses the data graph using the URL.

According to a second aspect, an embodiment of the present disclosure provides a data visualization apparatus, including a receiving module, configured to receive a data query request for data sent by a request side, where the data query request includes a query condition and a data graph type, an acquiring module, configured to acquire data according to the query condition obtained by the receiving module, where the data graph type is used for presentation of the data, and a processing module, configured to generate a data graph according to the data obtained by the acquiring module and the data graph type obtained by the receiving module.

With reference to the second aspect, in a first possible implementation manner of the second aspect, the processing module includes a determining unit, configured to determine whether a template corresponding to the data graph type has been loaded into the data visualization apparatus, and if the determining unit determines that the template corresponding to the data graph type has been loaded into the data visualization apparatus, trigger the processing module to apply the data to the template, to generate the data graph, or if the determining unit determined that the template corresponding to the data graph type has not been loaded into the data visualization apparatus, trigger the processing module to load the template into the data visualization apparatus and apply the data to the template, to generate the data graph.

With reference to the first possible implementation manner of the second aspect, in a second possible implementation manner of the second aspect, the determining unit is configured to search one or more data graph templates stored by the data visualization apparatus, to determine whether the template corresponding to the data graph type exists, and if the template corresponding to the data graph type exists, determine that the template corresponding to the data graph type has been loaded into the data visualization apparatus, or if the template corresponding to the data graph type does not exist, determine that the template corresponding to the data graph type has not been loaded into the data visualization apparatus.

With reference to any one of the second aspect and the first to second possible implementation manners of the second aspect, in a third possible implementation manner of the second aspect, if the data graph type is a customized template, the data query request further includes information indicating a location from which the customized template can be acquired.

With reference to any one of the second aspect and the first to the third possible implementation manners of the second aspect, in a fourth possible implementation manner of the second aspect, the apparatus further includes a response module, where the processing module is further configured to generate a URL that points to the data graph, and the response module is configured to send the URL as a response to the request side such that the request side accesses the data graph using the URL.

According to a third aspect, an embodiment of the present disclosure provides a database server, including a receiver, a data processing statement parser, a data processing command dispatcher, a data processing command executor, a data storage, and a graph engine, where the receiver is configured to receive a data query request for data, where the data query request includes a query condition and a data graph type, the data processing statement parser is configured to parse the data query request to obtain a data processing command and a graph generation command, where the data processing command includes the query condition, and the graph generation command includes the data graph type, the data processing command dispatcher is configured to dispatch the data processing command executor to acquire, according to the data processing command, data from the data storage, and the graph engine is configured to generate a data graph according to the graph generation command and the data.

With reference to the third aspect, in a first possible implementation manner of the third aspect, the graph engine is configured to determine whether a template corresponding to the data graph type has been loaded into the database server, and if it is determined that the template corresponding to the data graph type has been loaded into the database server, apply the data to the template, to generate the data graph, or if it is determined that the template corresponding to the data graph type has not been loaded into the database server, load the template into the database server and apply the data to the template, to generate the data graph.

With reference to the first possible implementation manner of the third aspect, in a second possible implementation manner of the third aspect, the determining, by the graph engine, whether a template corresponding to the data graph type has been loaded into the database server is searching one or more data graph templates stored by the database server, to determine whether the template corresponding to the data graph type exists, and if the template corresponding to the data graph type exists, determining that the template corresponding to the data graph type has been loaded into the database server, or if the template corresponding to the data graph type does not exist, determining that the template corresponding to the data graph type has not been loaded into the database server.

With reference to any one of the third aspect and the first to second possible implementation manners of the third aspect, in a third possible implementation manner of the third aspect, the data processing command dispatcher is further configured to initialize the graph engine before the data fed back by the data processing command executor and the graph generation command are sent to the graph engine.

With reference to any one of the third aspect and the first to third possible implementation manners of the third aspect, in a fourth possible implementation manner of the third aspect, if the data graph type is a customized template, the data query request further includes information indicating a location from which the customized template can be acquired.

With reference to any one of the third aspect and the first to fourth possible implementation manners of the third aspect, in a fifth possible implementation manner of the third aspect, the graph engine is further configured to generate a URL that points to the data graph, and send the URL as a response to a request side such that the request side accesses the data graph using the URL.

In the embodiments of the present disclosure, a query condition and a data graph type are carried in a data query request, and a data graph can be generated inside a database server. Therefore, it is unnecessary to develop software multiple times in different architectures to generate a data graph, which improves resource utilization, and has a relatively low skill requirement for an operator. In addition, a development process of an application involving graphics and reports is simplified, and development efficiency of the foregoing application is improved.

### BRIEF DESCRIPTION OF DRAWINGS

To describe the technical solutions in the embodiments of the present disclosure or in the prior art more clearly, the following briefly introduces the accompanying drawings for describing the embodiments or the prior art. The accompanying drawings in the following description show some embodiments of the present disclosure, and persons of ordinary skill in the art may still derive other drawings from these accompanying drawings without creative efforts.

FIG. 1 is a flowchart of Embodiment 1 of a data visualization method according to the present disclosure.

FIG. 2 is a schematic structural diagram of Embodiment 1 of a data visualization apparatus according to the present disclosure.

FIG. 3 is a schematic structural diagram of Embodiment 1 of a database server according to the present disclosure.

FIG. 4 is an exemplary diagram of a comparison between functions of a database server of the present disclosure and functions of a conventional database server.

FIG. 5 is an exemplary diagram of generation of a data graph in Embodiment 2 of a database server according to the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments include some but not all of the embodiments of the present disclosure. All other embodiments obtained by persons of ordinary skill in the art based on the embodiments of the present disclosure, without creative efforts, shall fall within the protection scope of the present disclosure.

FIG. 1 is a flowchart of Embodiment 1 of a data visualization method according to the present disclosure. This embodiment of the present disclosure provides a data visualization method, and the method may be executed by a device such as a data visualization apparatus or a database server, where the data visualization apparatus may be independently set, or may be integrated in a large data storage device such as a database server. As shown in FIG. 1, the method includes:

S101 A database server receives a data query request sent by a request side, where the data query request includes a query condition and a data graph type.

Generally, a data query request includes only a query condition, for example, the location of data and/or the size of data, but does not specify a presentation form of the data, and the found data further needs to be processed using a service language, to generate a data graph. In this embodiment, of the present disclosure, the data graph type is directly carried in the data query request such that a data graph is generated inside the device executing the method, and it is unnecessary to develop software for multiple times in different architectures. In addition, a development process of an application involving graphics and reports is simplified, and development efficiency of the foregoing application is improved.

In an embodiment, in a relational database, SQL syntax is extended in the present disclosure. A format of an extended SQL statement is standard SQL+a part that defines how to implement information virtualization, where the standard SQL represents SQL syntax used in the prior art, and the part that defines how to implement information virtualization is used to represent an extended part provided in this embodiment of the present disclosure, for example

Select................(ANSI SQL)--standard SQL--

as <pie/bar/line/area/custom>--extended syntax--

[uses <customized template url location>]--extended syntax--

[generateTo <external url>]--extended syntax--, where

“as” represents that the data graph is generated using a data graph type specified by a post parameter, and “custom” represents a customized template, when the parameter is set to custom, a service-customized data graph template is acquired using a template location specified by a user parameter, and “output” represents a location at which a data graph is to be generated. It should be noted that, such keywords herein and related keywords below (for example, “as”, “uses”, “generateTo”) are used for illustration only, and may be replaced with any suitable keyword in actual production, which is not limited in the present disclosure.

If the data graph type is a customized template, the data query request may further include information indicating a location from which the customized template can be acquired. Further, the data query request may further include information indicating a location of the data graph, and the like. For a data graph needing to be generated using the customized template, a location of the customized template needs to be specified in the extended SQL statement, for example Select avg(salary) from employee_table group by designation as pie uses customized_template_url. In this example, the location information of the data graph is represented using a URL, and the present disclosure is not limited thereto.

A data query request in the prior art and the data query request in this embodiment of the present disclosure are described below using examples, to clearly distinguish the two.

For example, in the prior art, the data query request is an SQL statement using the SQL syntax: Select * from userdetails where userId=“test_user_id_1”, where “userdetails” represents a location of data, and “userId=“test_user_id_1”” represents a condition that the data satisfies. In this embodiment of the present disclosure, to acquire a graph that is drawn using data the same as that in the foregoing SQL statement, the data query request is Select * from userdetails where userId=“test_user_id_1” as pie, where “as” represents that the data graph is generated using a data graph type specified by a post parameter, and “pie” represents the data graph type for presentation.

For another example, in the prior art, to acquire data the same as that of the foregoing SQL statement, the data query request is a NoSQL statement using non-relational database (NoSQL) syntax db.userdetails.find({“userId”“test_user_id_1”}). In this embodiment of the present disclosure, to acquire a graph drawn using data the same as that in the foregoing SQL statement, the data query request is db.userdetails.find({“userId”“test_user_id_1”}, {“as” “pie”}).

S102 The database server acquires data according to the query condition, where the data graph type is used for presentation of the data.

The database server parses the foregoing data query request, to obtain the query condition carried in the data query request, and obtains, according to the query condition, the data to be queried, that is, original data in the prior art or data obtained after original data is processed.

S103 The database server generates a data graph according to the data and the data graph type.

The data query request further carries the data graph type, therefore, the data obtained in S102 is applied to a template corresponding to the data graph type, to generate the data graph to be presented. A data graph is a graphical and visualized presentation form of information, data, and knowledge, and aims to transfer complex data information to a user in a clear, intuitive, and efficient manner.

In this embodiment of the present disclosure, a query condition and a data graph type are carried in a data query request, and a data graph can be generated inside a database server. Therefore, it is unnecessary to develop software multiple times in different architectures to generate a data graph, which improves resource utilization, and has a relatively low skill requirement for an operator. In addition, a development process of an application involving graphics and reports is simplified, and development efficiency of the foregoing application is improved.

In the foregoing embodiment, S103 may include determining whether a template corresponding to the data graph type has been loaded into the database server, and if it is determined that the template corresponding to the data graph type has been loaded into the database server, applying the data to the template, to generate the data graph, otherwise, loading the template into the database server and applying the data to the template to generate the data graph.

Determining whether a template corresponding to the data graph type has been loaded into the database server may include searching one or more data graph templates stored by the database server, to determine whether the template corresponding to the data graph type exists, and if the template corresponding to the data graph type exists, determining that the template corresponding to the data graph type has been loaded into the database server, or if the template corresponding to the data graph type does not exist, determining that the template corresponding to the data graph type has not been loaded into the database server.

Development of a service by applying this embodiment of the present disclosure is implemented using the following steps define a table or a view, define a visual structure for the table or the view, for example, the visual structure may be a pie chart, a bar chart, an area chart, a customized graph, or the like, define an implementation template for the table or the view, and complete creation of the table or the view. When the table or the view is created, a data graph type supported by the table or the view is specified. Each table or view matches one or more templates, to indicate how to generate a corresponding data graph. A template includes a series of graphic cache mapping tables for improving performance.

Based on the foregoing embodiment, S103 may include generating the data graph according to the data and the data graph type, and generating a URL that points to the data graph. Further, after generating by the database server the URL, the method may further include sending, by the database server, the URL as a response to the request side such that the request side accesses the data graph using the URL.

For the data query request of the request side, for example, a client, after obtaining the data graph, the database server receiving the data query request further needs to inform the request side of the location information of the data graph such that the request side displays the data graph. Herein, the database server responds to the request side using the URL, but the present disclosure is not limited thereto.

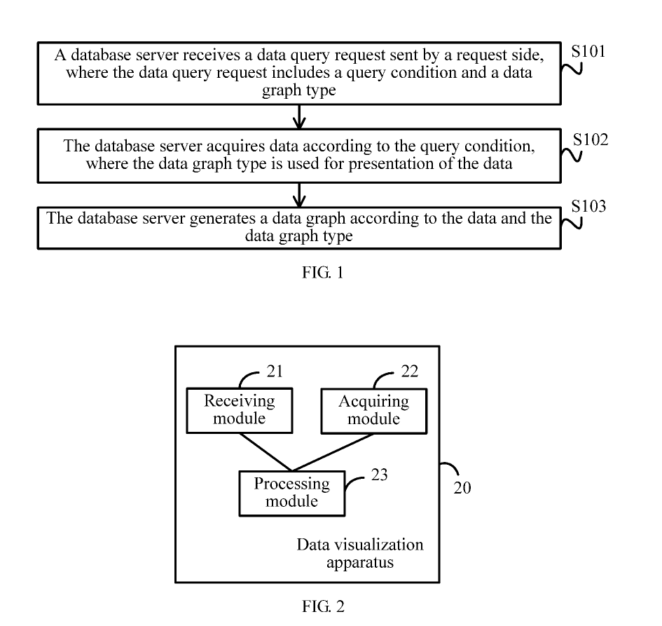

FIG. 2 is a schematic structural diagram of Embodiment 1 of a data visualization apparatus according to the present disclosure. As shown in FIG. 2, a data visualization apparatus 20 includes a receiving module 21, an acquiring module 22, and a processing module 23.

The receiving module 21 is configured to receive a data query request sent by a request side, where the data query request includes a query condition and a data graph type, the acquiring module 22 is configured to acquire data according to the query condition obtained by the receiving module 21, where the data graph type is used for presentation of the data, and the processing module 23 is configured to generate a data graph according to the data obtained by the acquiring module 22 and the data graph type obtained by the receiving module 21.

The apparatus in this embodiment may be used to execute the technical solution of the method embodiment shown in FIG. 1, and implementation principles and technical solutions thereof are similar, and are not described herein again.

In the foregoing embodiment, the processing module 23 may include a determining unit, configured to determine whether a template corresponding to the data graph type has been loaded into the data visualization apparatus 20, and if the determining unit determines that the template corresponding to the data graph type has been loaded into the data visualization apparatus 20, trigger the processing module 23 to apply the data to the template, to generate the data graph, otherwise, trigger the processing module 23 to load the template into the data visualization apparatus 20 and apply the data to the template, to generate the data graph.

Further, the determining unit may be configured to search one or more data graph templates stored by the data visualization apparatus 20 to determine whether the template corresponding to the data graph type exists, and if the template corresponding to the data graph type exists, determine that the template corresponding to the data graph type has been loaded into the data visualization apparatus 20, or if the template corresponding to the data graph type does not exist, determine that the template corresponding to the data graph type has not been loaded into the data visualization apparatus 20.

Optionally, if the data graph type is a customized template, the foregoing data query request may further include information indicating a location from which the customized template can be acquired, and the like.

Based on the foregoing description, the data visualization apparatus 20 may further include a response module (not shown in FIG. 2). In this embodiment, the processing module 23 may be further configured to generate a URL that points to the data graph. The response module is configured to send the URL as a response to the request side such that the request side accesses the data graph using the URL.

An embodiment of the present disclosure further provides a database server, where the database server has a built-in graph engine, to implement that during a data query process, a data graph is generated according to a data graph type that is specified in advance by a developer.

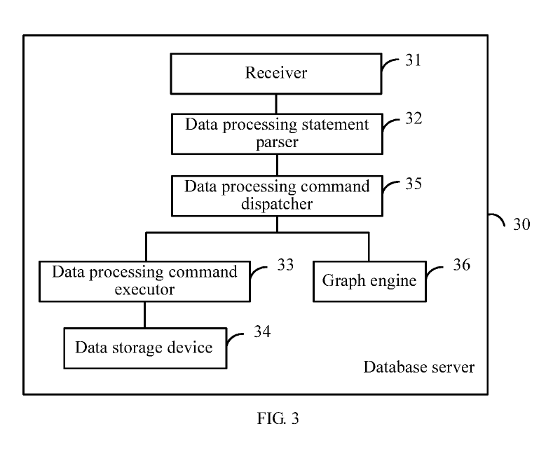

FIG. 3 is a schematic structural diagram of Embodiment 1 of a database server according to the present disclosure. As shown in FIG. 3, the database server 30 in this embodiment of the present disclosure includes a database server having standard functions, and components related to graphical processing, where the database server 30 having standard functions includes a receiver 31, a data processing statement parser 32, a data processing command executor 33, and a data storage device 34, and the components related to graphical processing include a data processing command dispatcher 35 and a graph engine 36. The database server 30 having standard functions takes responsibilities such as regular data acquisition and calculation, the data processing command dispatcher 35 is responsible for dispatching a data acquisition process, and after data is acquired, the data processing command dispatcher 35 transfers the data to the graph engine 36 such that the graph engine 36 generates a final data graph according to a data graph type specified by a user.

In an embodiment, the receiver 31 is configured to receive a data query request, where the data query request includes a query condition and a data graph type. The data processing statement parser 32 is configured to parse the data query request to obtain a data processing command and a graph generation command, where the data processing command includes the query condition, and the graph generation command includes the data graph type. The data processing command dispatcher 35 is configured to dispatch the data processing command executor 33 to acquire, according to the data processing command, data from the data storage device 34. The graph engine 36 is configured to generate a data graph according to the graph generation command and the data.

The graph engine 36 may be configured to determine whether a template corresponding to the data graph type has been loaded into the database server 30, and if it is determined that the template corresponding to the data graph type has been loaded into the database server 30, apply the data to the template, to generate the data graph, otherwise, load the template into the database server 30 and apply the data to the template, to generate the data graph.

Optionally, the determining, by the graph engine 36, whether a template corresponding to the data graph type has been loaded into the database server 30 includes searching one or more data graph templates stored by the database server 30, to determine whether the template corresponding to the data graph type exists, and if the template corresponding to the data graph type exists, determining that the template corresponding to the data graph type has been loaded into the database server 30, or if the template corresponding to the data graph type does not exist, determining that the template corresponding to the data graph type has not been loaded into the database server 30.

In the foregoing embodiment, if the data graph type is a customized template, the data query request may further include information indicating a location from which the customized template can be acquired, and the like, which is not limited in the present disclosure.

Further, the graph engine 36 may be further configured to generate a URL that points to the data graph, and send the URL as a response to a request side such that the request side accesses the data graph using the URL.

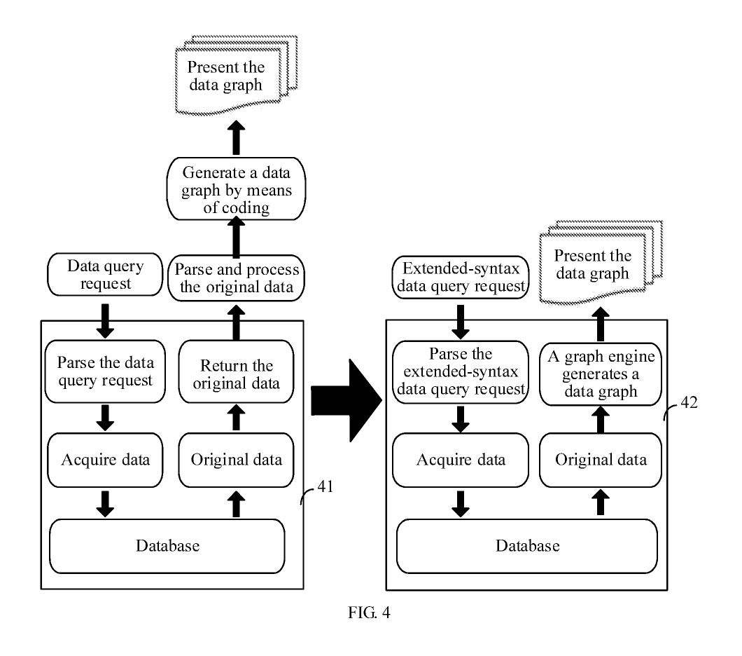

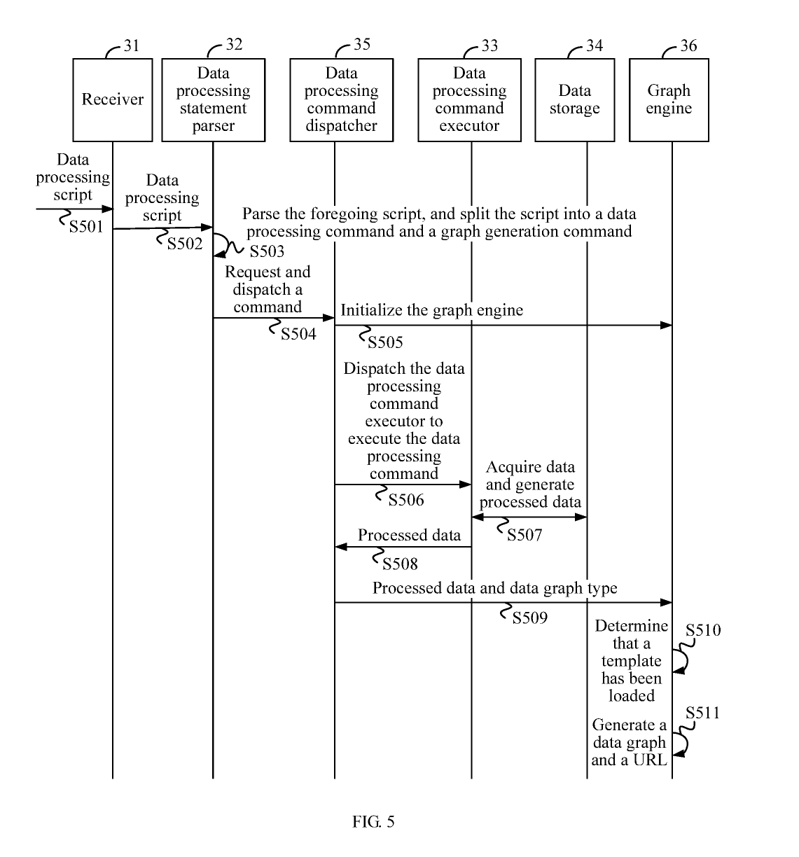

FIG. 4 is an exemplary diagram of a comparison between functions of a database server of the present disclosure and functions of a conventional database server.

As shown in FIG. 4, a conventional database server 41 receives a data query request, parses the data query request, acquires original data from a database, and returns the original data to a request side sending the data query request. Then, the request side parses and processes the original data, generates a data graph by means of coding, and presents the data graph.

Referring to FIG. 3 and FIG. 4, in this embodiment of the present disclosure, a database server 42 receives an extended syntax data query request, parses the extended syntax data query request, and acquires original data from a database. Further, a graph engine 36, in the database server 42, generates a data graph according to the original data, and sends the data graph as a response to a request side of the extended syntax data query request such that the request side presents the data graph.

It can be seen from the foregoing comparison that, the database server provided in this embodiment of the present disclosure has a data graph generation function, and can directly send a data graph as a response to a request side of a data query request according to the received data query request, where the data query request includes a data graph type.

Cooperative work among the foregoing components is described below using a signaling diagram, to describe generation of a data graph. As shown in FIG. 5, the cooperative work includes:

S501: The receiver 31 receives a data processing script entered by a data graph requester.

The foregoing data processing script is an extended data processing script, which as construed by persons skilled in the art, may include a query statement that includes a part that defines how to implement information virtualization, for example, the foregoing extended SQL statement or the foregoing extended NoSQL statement.

S502: The data processing statement parser 32 acquires the foregoing data processing script.

S503: The data processing statement parser 32 parses the foregoing data processing script, and splits the foregoing data processing script into a data processing command and a graph generation command.

The data processing command may be construed as a command that includes the foregoing query condition, or as another command for processing data. The graph generation command may be construed as a command including information related to generation of a data graph. For example, the command includes a data graph type and information about a template corresponding to the data graph type.

S504: The data processing statement parser 32 requests the data processing command dispatcher 35 to dispatch the commands.

The data processing command dispatcher 35 sequentially executes the commands.

S505: The data processing command dispatcher 35 initializes the graph engine 36.

The data processing command dispatcher initializes the graph engine 36 according to a status of the graph engine 36.

S506: The data processing command dispatcher 35 dispatches the data processing command executor 33.

S507: After being dispatched by the data processing command dispatcher 35, the data processing command executor 33 executes a data processing command, acquires data from the data storage 34, and obtains processed data.

Herein, the data processing command is the data processing command obtained after the data processing statement parser 32 parses the script.

S508: The data processing command executor 33 returns the processed data to the data processing command dispatcher 35.

S509: The data processing command dispatcher 35 dispatches the graph engine 36, and transfers the processed data and a data graph type to the graph engine 36.

The data graph type is specified by the data graph requester.

S510: The graph engine 36 determines that a data graph template corresponding to the data graph type has been loaded into the database server 30.

In an embodiment, the graph engine 36 determines, according to the data graph type, whether the data graph template corresponding to the data graph type has been loaded into the database server 30, and if the data graph template has not been loaded into the database server 30, loads the data graph template corresponding to the data graph type into the database server 30, and then performs S511, or if the data graph template has been loaded into the database server 30, directly performs S511.

S511: The graph engine 36 applies the processed data to the data graph template, to generate a data graph, and generates a URL that points to the data graph.

Then, the graph engine 36 sends the URL as a response to the data graph requester, and the data graph requester can access the generated data graph according to the URL.

In this embodiment of the present disclosure, a query condition and a data graph type are carried in a data query request, a data graph can be generated inside a database server, and a URL for accessing the data graph is sent to a data graph requester as a response such that the data graph requester accesses the data graph using the URL. Therefore, it is unnecessary to develop software multiple times in different architectures, which improves resource utilization, and has a relatively low skill requirement for an operator. In addition, a development process of an application involving graphics and reports is simplified, and development efficiency of the foregoing application is improved.

Persons of ordinary skill in the art may understand that all or some of the steps of the method embodiments may be implemented by a program instructing related hardware. The program may be stored in a computer-readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A data visualization method, comprising:
receiving, by a database server, a data query request for data sent by a request side, wherein the data query request comprises a query condition and a data graph type;
acquiring, by the database server, data according to the query condition, wherein the data graph type is used for presentation of the data; and
generating, by the database server, a data graph according to the data and the data graph type.

2. The data visualization method according to claim 1, wherein generating, by the database server, the data graph according to the data and the data graph type comprises:
determining whether a template corresponding to the data graph type has been loaded into the database server;
applying the data to the template to generate the data graph when the template corresponding to the data graph type has been loaded into the database server; and
loading the template into the database server and applying the data to the template, to generate the data graph when the template corresponding to the data graph type has not been loaded into the database server.

3. The data visualization method according to claim 2, wherein determining whether the template corresponding to the data graph type has been loaded into the database server comprises:
searching one or more data graph templates stored by the database server to determine whether the template corresponding to the data graph type exists; and
determining that the template corresponding to the data graph type has been loaded into the database server when the template corresponding to the data graph type exists.

4. The data visualization method according to claim 2, wherein determining whether the template corresponding to the data graph type has been loaded into the database server comprises:
searching one or more data graph templates stored by the database server to determine whether the template corresponding to the data graph type exists; and
determining that the template corresponding to the data graph type has not been loaded into the database server when the template corresponding to the data graph type does not exist.

5. The data visualization method according to claim 1 wherein the data query request further comprises information indicating a location from which the customized template can be acquired when the data graph type is a customized template.

6. The data visualization method according to claim 3, wherein generating, by the database server, the data graph according to the data and the data graph type comprises:
generating the data graph according to the data and the data graph type;
generating a uniform resource locator (URL) that points to the data graph; and
sending, by the database server, the URL as a response to the request side such that the request side accesses the data graph using the URL after generating the data graph according to the data and the data graph type and the URL that points to the data graph.

7. The data visualization method according to claim 4, wherein generating, by the database server, the data graph according to the data and the data graph type comprises:
generating the data graph according to the data and the data graph type;
generating a uniform resource locator (URL) that points to the data graph; and
sending, by the database server, the URL as a response to the request side such that the request side accesses the data graph using the URL after generating the data graph according to the data and the data graph type and generating the URL that points to the data graph.

8. A data visualization apparatus, comprising:
a non-transitory computer-readable storage medium comprising programming instructions; and
a processor coupled to the non-transitory computer-readable storage medium, wherein the programming instructions cause the processor to be configured to:
receive a data query request for data sent by a request side, wherein the data query request comprises a query condition and a data graph type;
acquire data according to the query condition, wherein the data graph type is used for presentation of the data; and
generate a data graph according to the data and the data graph type.

9. The data visualization apparatus according to claim 8, wherein the programming instructions further cause the processor to be configured to:
determine whether a template corresponding to the data graph type has been loaded into the data visualization apparatus;
trigger to apply the data to the template to generate the data graph when the template corresponding to the data graph type has been loaded into the data visualization apparatus; and
trigger to load the template into the database visualization apparatus and apply the data to the template, to generate the data graph when the template corresponding to the data graph type has not been loaded into the data visualization apparatus.

10. The data visualization apparatus according to claim 9, wherein the programming instructions further cause the processor to be configured to:
search one or more data graph templates stored by the data visualization apparatus to determine whether the template corresponding to the data graph type exists; and
determine that the template corresponding to the data graph type has been loaded into the data visualization apparatus when the template corresponding to the data graph type exists.

11. The data visualization apparatus according to claim 9, wherein the programming instructions further cause the processor to be configured to:
search one or more data graph templates stored by the data visualization apparatus, to determine whether the template corresponding to the data graph type exists; and
determine that the template corresponding to the data graph type has not been loaded into the data visualization apparatus when the template corresponding to the data graph type does not exist.

12. The data visualization apparatus according to claim 8, wherein the data query request further comprises information indicating a location from which the customized template can be acquired when the data graph type is a customized template.

13. The data visualization apparatus according to claim 8, wherein programming instructions further cause the processor to be configured to:
generate a uniform resource locator (URL) that points to the data graph; and
send the URL as a response to the request side such that the request side accesses the data graph using the URL.

14. A database server, comprising:
a receiver configured to receive a data query request for data, wherein the data query request comprises a query condition and a data graph type; and
a processor coupled to the receiver and configured to:
parse the data query request to obtain a data processing command and a graph generation command, wherein the data processing command comprises the query condition, and wherein the graph generation command comprises the data graph type;
acquire, according to the data processing command, the data from the data storage; and
generate a data graph according to the graph generation command and the data.

15. The database server according to claim 14, wherein the processor is further configured to:
determine whether a template corresponding to the data graph type has been loaded into the database server;
apply the data to the template to generate the data graph when the template corresponding to the data graph type has been loaded into the database server; and
load the template into the database server and apply the data to the template, to generate the data graph when the template corresponding to the data graph type has not been loaded into the database server.

16. The database server according to claim 14, wherein, when determining whether the template corresponding to the data graph type has been loaded into the database server, the processor is further configured to:
search one or more data graph templates stored by the database server to determine whether the template corresponding to the data graph type exists; and
determine that the template corresponding to the data graph type has been loaded into the database server when the template corresponding to the data graph type exists.

17. The database server according to claim 14, wherein, when determining whether the template corresponding to the data graph type has been loaded into the database server, the processor is further configured to:
search one or more data graph templates stored by the database server to determine whether the template corresponding to the data graph type exists; and
determine that the template corresponding to the data graph type has not been loaded into the database server when the template corresponding to the data graph type does not exist.

18. The database server according to claim 14, wherein the processor is further configured to initialize a graph engine before the data and the graph generation command are sent to the graph engine.

19. The database server according to claim 14, wherein the data query request further comprises information indicating a location from which the customized template can be acquired when the data graph type is a customized template.

20. The database server according to claim 14, wherein the processor is further configured to generate a uniform resource locator (URL) that points to the data graph, and wherein the database server further comprises a transmitter coupled to the processor and configured to send the URL as a response to a request side such that the request side accesses the data graph using the URL.
